(19) United States
(12) Patent Application Publication
(10) Pub. No.: US 2010/0171681 A1
(43) Pub. Date: Jul. 8, 2010

(54) METHOD AND APPARATUS FOR DISPLAYING DIGITAL DATA

(76) Inventors: Manuel Cabanas, Brookline, MA (US); Hayley Greenberg, Brookline, MA (US)

Correspondence Address: Mark J. Pandiscio;Pandiscio & Pandiscio, P.C., 470 Totten Pond Road, Waltham, MA, 02451-1914, US

(21) Appl. No.: 12/652,526

(22) Filed: Jan. 5, 2010

Related U.S. Application Data
(60) Provisional application No. 61/142,492, filed on Jan. 5, 2009.

(51) Int. Cl. G09G 3/00

(52) U.S. Cl. 345/31

(57) ABSTRACT

A rotary display device comprising one or more vertical arrays of light-emitting diodes (LEDs) are rotated and energized at a controlled rate so as to project a 360 degree floating image. The displayed images are viewable from all angles (i.e., 360 degrees). The LEDs and associated control electronics are rotated at a desired speed, e.g., between about 720 and about 3600 revolutions per minute, by an AC or DC motor. Display content is either pre-loaded to the rotary display or transferred to the rotary display during device operation via a cellular telephone, Wi-Fi, Bluetooth, etc. connection. The electrical power for the system, including the LED array and the control electronics, is provided via a contact-less rotary transformer that functions independently of the rotation speed.

### REFERENCE TO PENDING PRIOR PATENT APPLICATION

This patent application claims benefit of pending prior U.S. Provisional Patent Application Ser. No. 61/142,492, filed Jan. 5, 2009 by Manuel Cabanas et al. for DIGITAL ROTATING SIGN “DRS”™ DEVICE (Attorney's Docket No. CABANAS-1 PROV), which patent application is hereby incorporated herein by reference.

### FIELD OF THE INVENTION

This invention relates to methods and apparatus for displaying digital data in general, and more particularly to methods and apparatus for displaying digital data as a 360 degree image.

### BACKGROUND OF THE INVENTION

Large digital information and entertainment displays based on two-dimensional arrays of light-emitting diodes (LEDs), or other discrete light sources, are well known in the art. These two-dimensional arrays of LEDs are generally arranged in a planar configuration. As a result, while there are many applications for such displays, their planar configuration causes them to have a limited viewing angle (i.e., 180 degrees or less).

Due to this limitation, where it is desirable to present an image across a larger viewing angle, it is generally necessary to provide the LEDs in an arcuate configuration and, where it is necessary to present the image across a 360 degree viewing angle, to provide the LEDs in a cylindrical configuration. Thus, efforts have been made to create a cylindrical array of LEDs, however, this approach is relatively expensive and complex due to the large number of LEDs required for the display and the related electronics required to drive those LEDs.

It has been found that, where it is desirable to present an image across a 360 degree viewing angle, it is generally more economical to utilize a rotary display. More particularly, such a rotary display typically comprises a vertical array of light-emitting elements which is rotated about a center axis, and pulsed in an appropriate sequence and at an appropriate rate, so as to present a fixed image to a viewer using the “persistence of vision” phenomenon associated with the human eye. In essence, this approach presents the image as if it were projected from the outer surface of a cylinder, i.e., as a 360 degree image.

In practice, it has been found that such a rotary display typically has greater appeal to a viewer than a conventional “flat” LED display, thereby making rotary displays particularly desirable in the fields of advertising and information display.

In view of the foregoing, various efforts have been made to provide rotary displays of the sort discussed above. However, all of the rotary displays produced to date suffer from one or more significant limitations. Among other things, all of the rotary displays produced to date have deficiencies in the manner by which the digital content is uploaded to the rotating portion of the rotary display.

More particularly, in some cases, the digital content is stored directly on the rotating portion of the rotary display, e.g., in read-only memory (ROM) located adjacent to the light-emitting elements. This approach has the advantage of simplifying delivery of the digital content to the light-emitting elements, since they are both located on the rotating portion of the rotary display, but it also requires that the rotation of the rotary display be stopped in order to replace or reprogram the digital content.

In other cases, the digital content is stored in a stationary “controller” mounted in a base (e.g., in a non-rotating portion of the rotary display) and is uploaded to the rotating light-emitting elements, which are located on the rotating portion of the rotary display. By way of example, the digital content is commonly uploaded to the rotating portion of the rotary display via the same electro-mechanical rotary coupling which transmits power to the rotating light-emitting elements, or by a line-of-sight electro-optical coupling, or by a line-of-sight microwave coupling, etc. This approach has the advantage that the digital content can be easily loaded into the stationary controller, but it has the disadvantage that the digital content must be transferred from the stationary controller to the rotating portion of the rotary display through an electro-mechanical coupling or through a line-of-sight coupling. This need to transfer the digital content through such a coupling adds to the complexity of the device, increases cost, increases size, limits installation options and raises reliability issues.

Furthermore, prior art rotary displays have traditionally been “stand-alone” devices intended for solitary functionality.

As a result, there is a need for a new and improved rotary display.

### SUMMARY OF THE INVENTION

The present invention provides a new method and apparatus for displaying digital data. More particularly, the present invention comprises the provision and use of a new and improved rotary display which displays the digital data as a 360 degree translucent or transparent “floating” image. To this end, the new rotary display utilizes a vertical array of light-emitting elements which is rotated on an arm about a center axis, and pulsed in an appropriate sequence and at an appropriate rate, so as to present a fixed image to a viewer using the “persistence of vision” phenomenon associated with the human eye. The control electronics are mounted to the rotating arm adjacent to the light-emitting elements. Display content is either pre-loaded to the control electronics, or transferred to the control electronics during device operation, via a wireless (e.g., cellular telephone, Wi-Fi, Bluetooth, etc.) connection. The electrical power for the LED array and the control electronics is provided via a contact-less rotary transformer that functions independently of the rotation speed.

In one form of the present invention, there is provided apparatus for displaying digital content to a viewer, the apparatus comprising: a rotary display, the rotary display comprising:
a motor having a motor shaft;
at least one support arm mounted to the motor shaft and extending radially outboard from the motor shaft;
at least one array of light-emitting elements mounted to the outboard end of the at least one support arm;
a wireless antenna mounted to the motor shaft; and
a controller mounted to the motor shaft for controlling operation of the at least one array of light-emitting elements, the controller being connected to the wireless antenna for receiving digital content received by the wireless antenna from a remote source and pushing that digital content to the at least one array of light-emitting elements in an appropriate sequence and at an appropriate rate so as to present a fixed image to a viewer using the “persistence of vision” phenomenon associated with the human eye.

In another form of the present invention, there is provided a method for displaying digital content to a viewer, the method comprising:

providing a rotary display, the rotary display comprising:
a motor having a motor shaft;
at least one support arm mounted to the motor shaft and extending radially outboard from the motor shaft;
a least one array of light-emitting elements mounted to the outboard end of the at least one support arm;
a wireless antenna mounted to the motor shaft; and
a controller mounted to the motor shaft for controlling operation of the at least one array of light-emitting elements, the controller being connected to the wireless antenna for receiving digital content received by the wireless antenna from a remote source and pushing that digital content to the at least one array of light-emitting elements in an appropriate sequence and at an appropriate rate so as to present a fixed image to a viewer using the “persistence of vision” phenomenon associated with the human eye;

wirelessly transmitting digital content from a remote source to the controller via the wireless antenna; and

pushing the digital content from the controller to the at least one array of light-emitting elements in an appropriate sequence and at an appropriate rate so as to present a fixed image to a viewer using the “persistence of vision” phenomenon associated with the human eye.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic perspective view of a novel rotary display formed in accordance with the present invention;

FIG. 2 is a schematic perspective view of the novel rotary display of FIG. 1, but with the transparent display enclosure removed;

FIG. 3 is a schematic view of the apparatus shown in FIG. 2, but from a different angle of view and with some of the apparatus removed so as to expose internal components;

FIG. 4 is a schematic close-up view of some of the apparatus shown in FIG. 3, taken from a different angle of view;

FIG. 5 is a schematic sectional view of the apparatus shown in FIG. 4;

FIG. 6 is a schematic view of the wireless ring antenna of the new rotary display;

FIG. 7 is schematic block diagram of the various electrical components of the new rotary display;

FIG. 8 is a schematic block diagram of the digital circuitry of the new rotary display; and

FIGS. 9 and 10 are schematic views showing examples of the new rotary display in use.

### DETAILED DESCRIPTION OF THE PREFERRED EMBODIMENTS

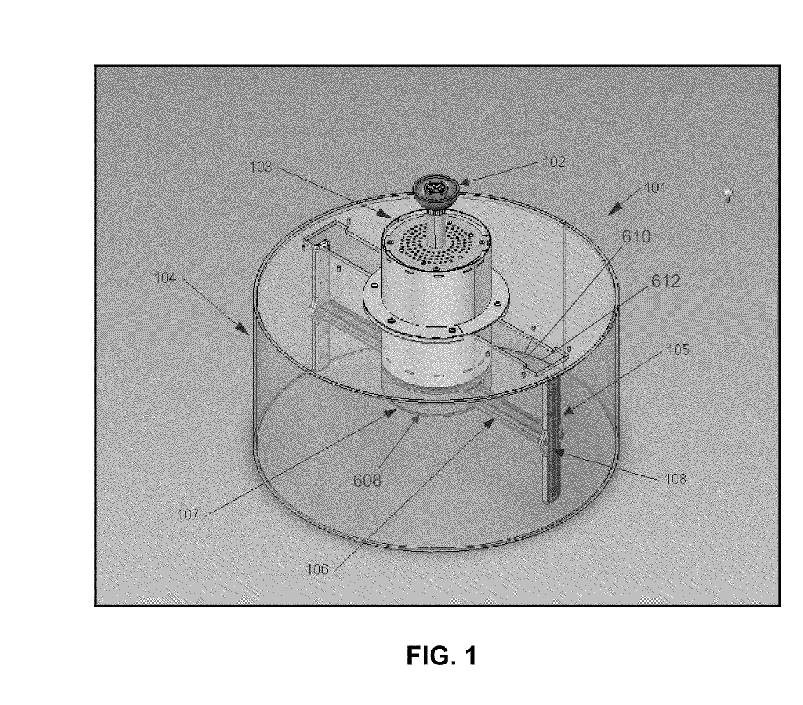

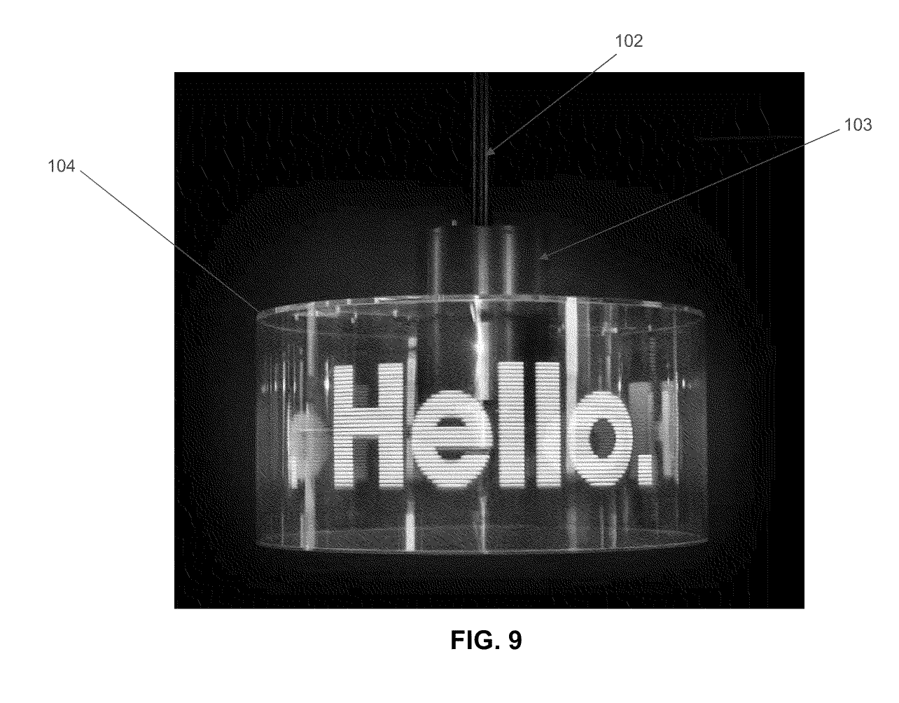

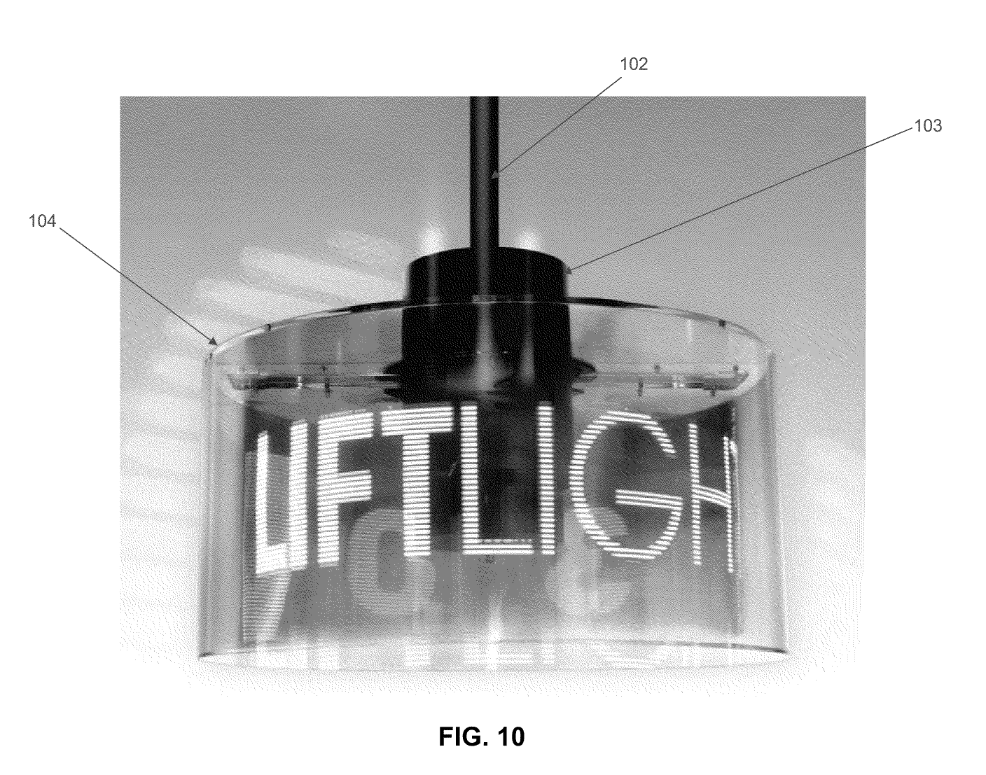

Looking first at FIGS. 1-3, there is shown a novel rotary display 101 formed in accordance with the present invention. As will hereinafter be discussed in further detail, rotary display 101 is adapted to display digital data as a 360 degree translucent or transparent “floating” image (see FIGS. 9 and 10) and, to this end, comprises a vertical array of light-emitting elements which is rotated on an arm about a center axis, and pulsed in an appropriate sequence and at an appropriate rate, so as to present a fixed image to a viewer using the “persistence of vision” phenomenon associated with the human eye, whereby to provide a 360 degree floating image which is viewable from all angles. The control electronics are mounted to the rotating arm adjacent to the light-emitting elements. Display content is either pre-loaded to the control electronics, or transferred to the control electronics during device operation, via a wireless (e.g., cellular telephone, Wi-Fi, Bluetooth, etc.) connection. The electrical power for the LED array and the control electronics is provided via a contact-less rotary transformer that functions independently of the rotation speed.

More particularly, and still looking now at FIGS. 1-3, rotary display 101 comprises a vertically oriented support structure (i.e., motor housing) 103 into which a motor 202 is mounted, with the motor shaft 212 extending through a mounting plate 602 which is secured to motor 202. Motor housing 103 can be mounted (as shown) to a widely available ceiling fan mount 102, or motor housing 103 can be mounted to a display stand, or motor housing 103 can be mounted, inverted, on a pedestal. In this latter inverted configuration, the electronic image of rotary display 101 is flipped vertically by electronic means for proper presentation to the viewer.

Motor housing 103 supports a transparent display enclosure 104, as well as all of the working parts of rotary display 101. The interior surface of the transparent display enclosure 104 is preferably reflective, so that the displayed image (see FIGS. 9 and 10) can be seen both directly and by reflection off the interior of the display enclosure. By enabling the displayed image to be seen both directly and by reflection off of the interior of the display enclosure, a viewer located at a single point of view can experience a full 360 degree floating ring image. A hub assembly 107, mounted to motor shaft 212, is rotated by motor 202, as is one or more support arms 106 and one or more LED array holders 105 disposed at the distal end of each support arm 106.

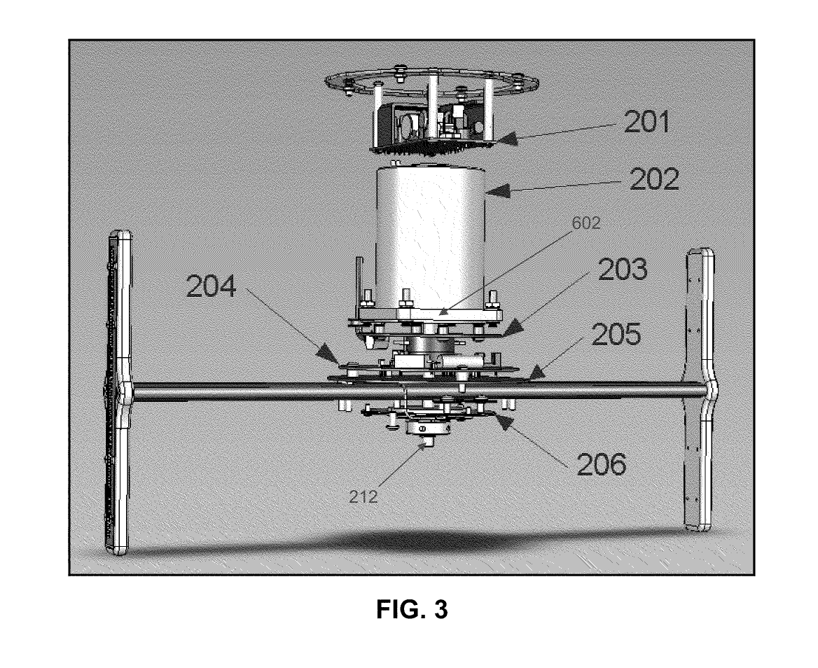

FIG. 3 shows rotary display 101 with transparent display enclosure 104 removed and with motor housing 103 removed. Below motor 202, and attached to mounting plate 602, is a stator printed circuit board (PCB) 203, which comprises one element of an inductive rotating transformer, as will hereinafter be discussed in further detail. Motor shaft 212 extends through stator PCB 203.

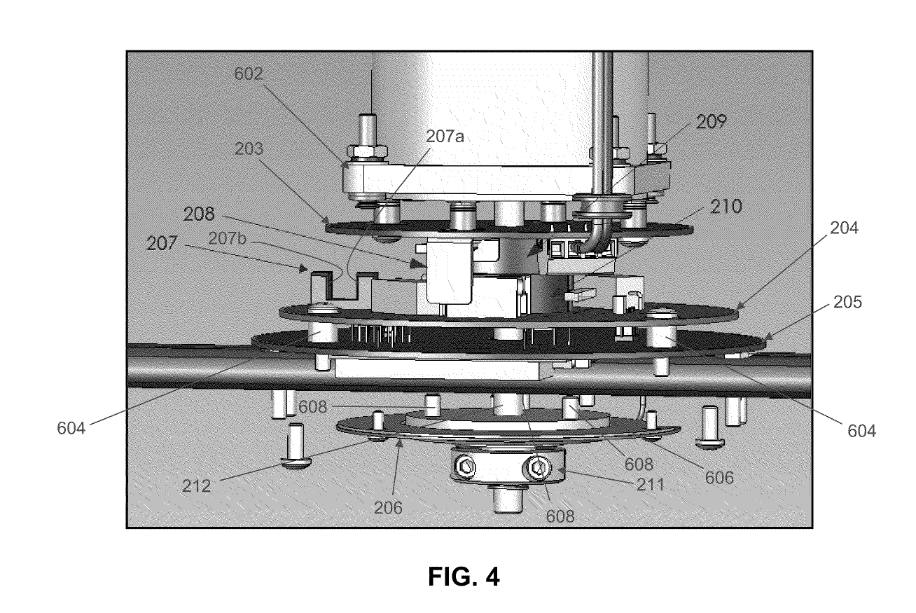

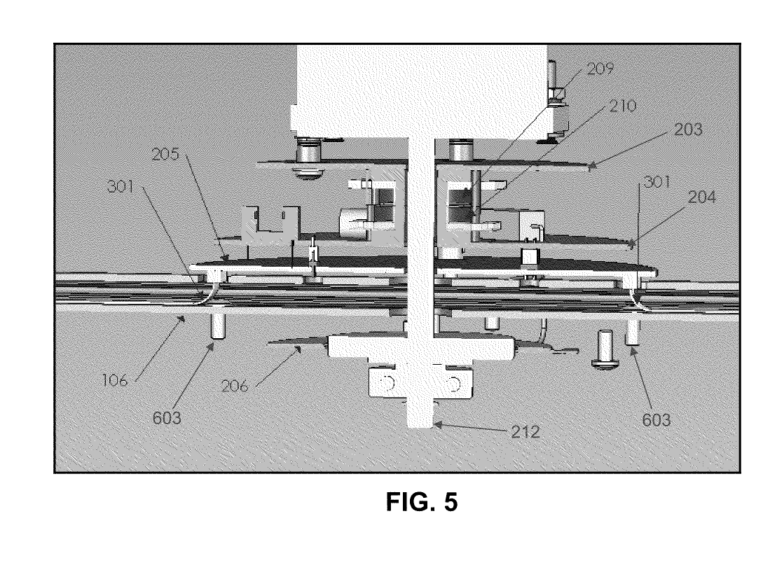

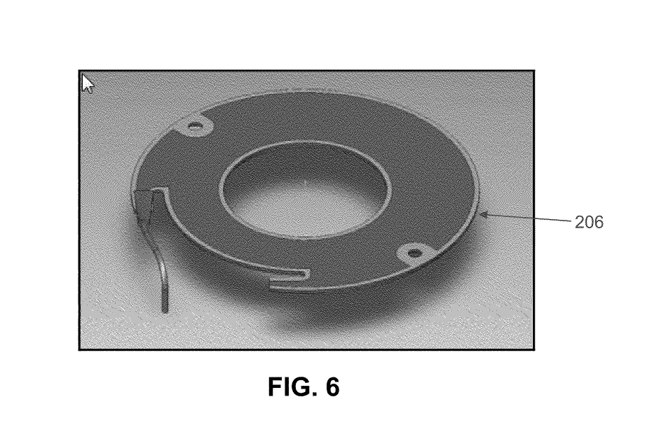

Looking now at FIGS. 3-6, attached to motor shaft 212, under stator PCB 203, is a rotor printed circuit board (PCB) 204, a hub electronics board 205, and a mounting collar 211. Rotor PCB 204 faces stator PCB 203. Electrical power is inductively coupled from the transformer stator 209 (FIGS. 4 and 5) to the transformer rotor 210 across an air-gap, without mechanical contact.

Hub electronics board 205 is attached, via two sets of connectors 603, to support arms 106. Hub electronics board 205 is also attached, via three sets of mounts 604, to the bottom of rotor PCB 204. A wireless ring antenna 206 is attached to hub electronics board 205. As a result of this construction, rotor PCB 204, hub electronics board 205, support arms 106 and wireless ring antenna 206 are effectively secured together as a unit. Hub electronics board 205 and rotor PCB 204 are attached to a mounting hub 606 via three mounting screws 608. Motor shaft 212 passes through stator PCB 203, rotor

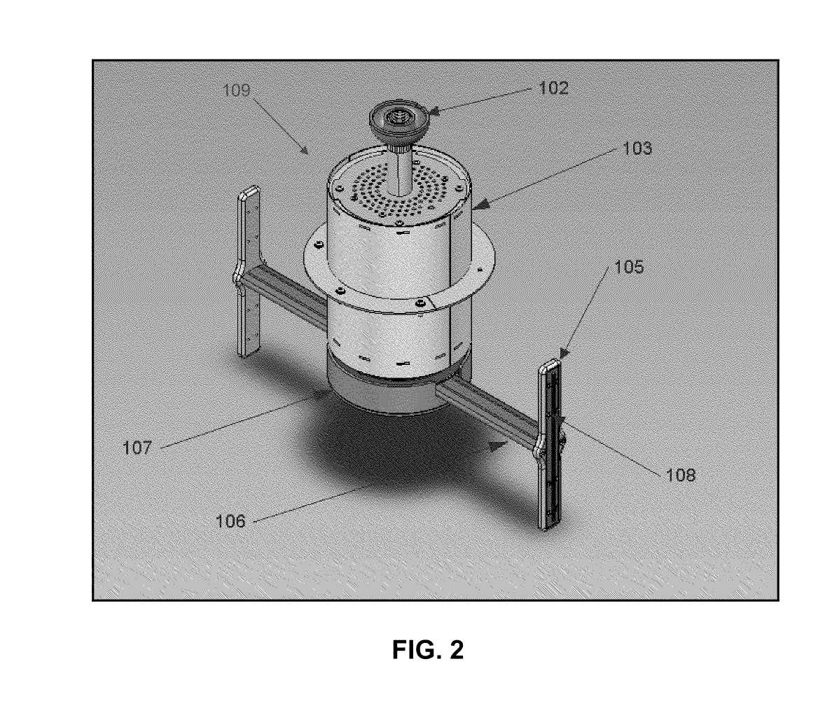

PCB 204, hub electronics board 205, support arms 106 and wireless ring antenna 206, and is attached to mounting hub 606, via a shaft locking collar 211. Motor 202 rotates hub assembly 107 (which comprises rotor PCB 204, hub electronics board 205, support arms 106, wireless ring antenna 206 and the hub assembly cover 608) as a unit. As seen in FIG. 1, a slot 610 (with a removable cover 612) in the top of transparent display enclosure 104 permits easy removal of internal assembly 109 (FIG. 2) from the interior of transparent display enclosure 104. Alternatively, where rotary display 101 is mounted to a ceiling, e.g., with ceiling fan mount 102, slot 610 (with removable cover 612) in the top of transparent display enclosure 104 permits easy removal of transparent display enclosure 104 from the remainder of the rotary display, whereby to expose the internal components of the rotary display.

FIG. 4 also shows a photo-interrupter-type position sensor 207 mounted on rotor PCB 204 and connected to hub electronics board 205. Position sensor 207 passes a beam of light (preferably infrared) from an LED transmitter 207A to a light receiver 207B. This beam of light is broken when an index blade 208, mounted to stator PCB 203, intermittently blocks the beam of light as hub assembly 107 rotates on motor shaft 212. This light-blocking event is used by software in hub electronics board 205 to compute the speed of rotation of motor shaft 212, and hence the speed of rotation of LED array holders 105 located at the outboard ends of support arms 106, and can also be used to determine the angular position of LED arrays 108 which are used to display the digital data. An accurate computation of this speed of rotation, and an accurate knowledge of the angular position of LED arrays 108, is important in order to ensure proper presentation of the digital data which is to be displayed by the LED arrays 108 carried on LED array holders 105.

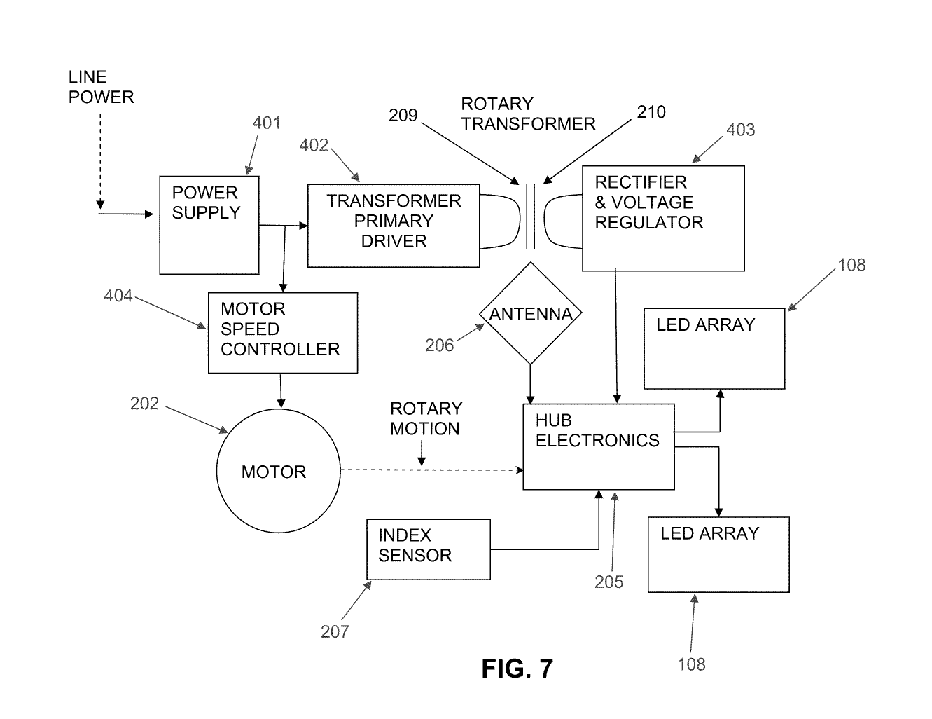

FIG. 3, along with the block diagram of FIG. 7, illustrates the relationship between the various electrical components of rotary display 101. Power supply PCB 201 (FIG. 3) accepts most international line power voltages and provides DC power to the rotary display via power supply 401 (FIG. 7). DC power supply 401 supplies power to a motor speed controller 404 which is preferably contained within the body of motor 202. Motor speed controller 404 precisely regulates the speed of motor 202, and is preferably manually adjustable in order to set the optimal operating speed for motor 202 (which, in turn, is used to set the display refresh rate).

DC power supply 401 also supplies power to the display electronics (carried by hub electronics board 205) via a transformer primary driver 402 located on stator PCB 203 and communicating with transformer stator 209. By pulsing the voltage across rotary transformer stator 209, transformer primary driver 402 couples power to rotary transformer rotor 210. Rotary transformer rotor 210 is connected to a rectifier and voltage regulator 403 located on rotor PCB 204 which, in turn, supplies regulated power to hub electronics board 205. As will hereinafter be described in further detail, hub electronics board 205 is connected to, and drives LED arrays 108.

FIG. 5 shows much of what is described above in cross-section. FIG. 5 also shows cable connections 301 which extend between hub electronics board 205 and

LED arrays 108. FIG. 5 also shows how rotary power is transferred from motor shaft 212 to rotating rotor PCB 204, hub electronics PCB 205, wireless ring antenna 206 and support arms 106 (which in turn carry LED array holders 105 and LED arrays 108).

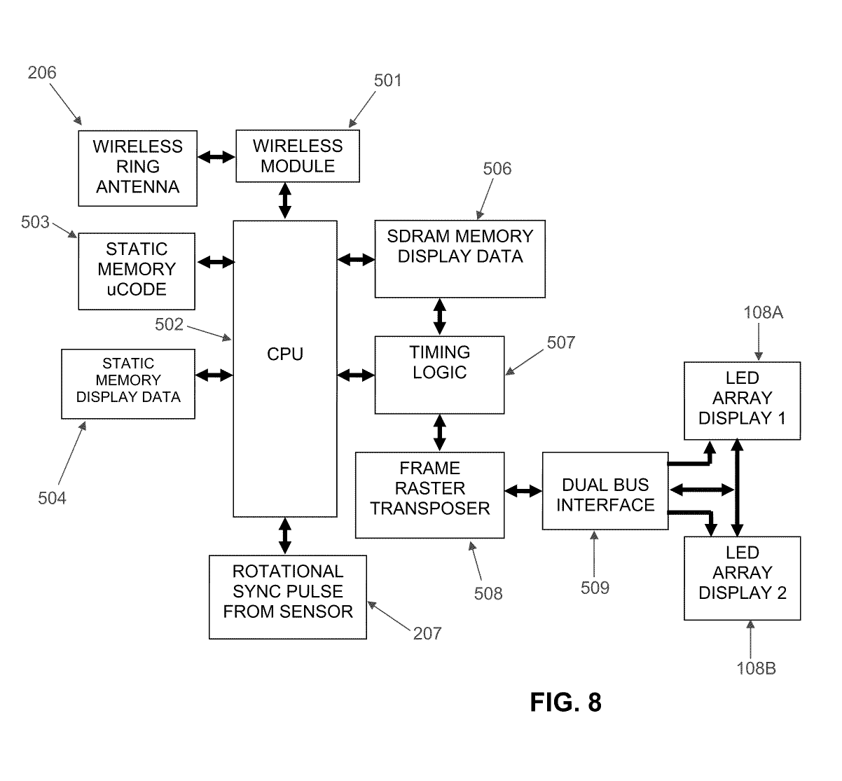

FIG. 8 is a block diagram showing the electronic circuitry of hub electronics board 205 and LED arrays 108. A wireless module 501 interfaces, via wireless ring antenna 206, with a wireless network, whereby to upload digital content to rotary display 101, to allow rotary display 101 to communicate with the wireless network, and/or to communicate with other rotary displays, as will hereinafter be discussed in further detail. This wireless module 501 is intended to be one which is appropriate for the wireless network which is to be accessed, e.g., a cellular telephone network, a Wi-Fi network, a Bluetooth connection, etc. Preferably, the wireless network is a “non-proprietary”, “industry-standard” wireless network, although the wireless network may be a proprietary, non-standard wireless network if desired. If desired, multiple wireless modules 501 may be installed on hub electronics board 205 in order to permit simultaneous multi-mode access by the rotary display to multiple networks. Wireless module 501 communicates with a CPU 502 using a standard peripheral communication means (e.g., asynchronous serial communications, PCI communications, etc.). CPU 502 is preferably a standard embedded microprocessor of the sort well known in the art. CPU 502 is supported by static memory microcode 503, preferably contained in non-volatile reprogrammable memory (e.g., PROM), for providing CPU 502 with system booting code and basic operating system code. CPU 502 may also include internal or external volatile working memory for program execution. Additional non-volatile rewriteable memory 504 may be provided for storing any display content which is to be rendered by default during boot operation, or as data which is to be displayed when no external content is available or when an application requires complete self-contained information to be displayed. However, in normal operation, where the digital data to be displayed is received from a remote wireless source via wireless ring antenna 206 and wireless module 501, the information which is to be displayed resides in dynamic memory 506. A built-in display controller with direct memory access (DMA) support in CPU 502 transfers display data from dynamic memory 506 to the frame raster transposer 508 under the control of timing logic 507, which may be of the sort typically provided to drive a flat panel (LCD) display.

More particularly, the digital data which is to be displayed is stored in display data memory 506, and the DMA engine and LCD controllers are programmed to present data to LED arrays 108 column by column, with data going to the “zero degree” and “180 degree” LED arrays 108A and 108B, respectively, interleaved in such a way that the LEDs in both arms may be energized simultaneously. Dual bus interface 509 steers data first to one LED array 108A, 108B, and then the other. Each LED array 108A, 108B employs serial and parallel registers such that data is shifted to each LED array via the serial registers and then latched into the parallel registers.

Each LED in LED arrays 108A, 108B preferably includes a red light-emitting junction, a green light-emitting junction and a blue light-emitting junction. In one preferred form of the invention, there are 48 LEDs (containing 146 light-emitting junctions) in a column, e.g., 48 red light-emitting junctions, 48 green light-emitting junctions and 48 blue light-emitting junctions. Each driver device energizes 16 individual LED junctions. Each drive point can be calibrated with information stored in non-volatile memory within each driver device in order to compensate for the electro-optical characteristic of the particular LED junction being driven. The process of adjusting the nominal current to each LED is known as “white balance” and is well known in the color television and imaging fields.

To render multiple color combinations, intensity data controls how long each LED remains energized during the time required for a rotating LED array 108 to travel from one displayed column to the next. For example, if an LED junction can remain energized for one of sixteen possible pulse widths, the visual effect is of sixteen different intensity levels. Thus, if each of the three colors has an intensity range with sixteen steps, 4096 different color combinations can be visually rendered. Thus, after data has been shifted serially to each array and latched, LEDs are energized by a precisely timed control pulse to each array.

To illustrate the synchronizing problem, consider what happens as each column successively passes the observer's eye. Illumination of the LEDs must be precisely synchronized to generate the same pattern as the previous column for a static display or to generate a smooth apparent motion if the display image is scrolling. This effect is similar to registering the even and odd fields in an interlaced video display. In a preferred form of the invention having two support arms 106 each carrying an LED array 108, the two LED columns must be located precisely 180 degrees apart. Otherwise, timing of column illumination must be shifted to effectively ensure that each column is illuminated precisely as it passes a given angular position. For more than two equally-spaced LED arrays, both data sequencing and fine timing must be adjusted accordingly.

To create a smooth display and increase resolution, and because it is difficult to fully light adjacent rows in an LED column, it is desirable to vertically offset alternate columns of LEDs on a given LED array 108, for example by one-half row spacing (where row spacing is defined as the vertical center-to-center spacing between LEDs in a given column), and interlacing column data according to what is required by the even and odd rows. One way of accomplishing this is to mount two columns of LEDs in each LED array 108. The horizontal spacing between the two columns translates to an angular difference between them. Timing of the illumination of each of the LED columns would then be adjusted by the electronic control circuitry, using well known phase lock techniques, to cause apparent vertical registration of the displayed data. This technique is an alternative to interlacing column data over multiple arms.

Stated another way, regarding the vertical offset of the LED columns, the issue is that when stacking LEDs one on top of the other, it is difficult to achieve an image without unlit horizontal lines. This is due to the dimensions of the LED package such that there is a certain amount of unlit space between each light source. One way to increase the resolution and eliminate the unlit lines is to have another column of LEDs that is vertically offset from the first column by ½ the distance between the center of two LEDs. The light is strobed in such a way as to create one column of data from the two columns of LEDs (e.g., two columns of 48 LEDs, or pixels, effectively give 96 vertical pixels per column). It is significant to note that, in this arrangement, the vertically-offset column of LEDs resides in the same LED array, and on the same circuit board, as the non-vertically-offset column. Thus, the present invention provides a means for increasing the vertical resolution of the display without requiring the need for additional LED arrays (and hence additional support arms 106).

Thus it will be seen that rotary display 101 generally comprises a motor 202 having a motor housing 103 and a drive shaft 212. Motor housing 103 is intended to be mounted to a mounting device 102, e.g., such as a typical ceiling fan mount. Motor housing 103 preferably includes a DC power supply 201 suitable for converting standard plug voltage into the DC power required by rotary display 101, whereby to drive motor 202 of the rotary display and to power its working electronics, as will hereinafter be discussed in further detail.

At least one support arm 106 is secured to drive shaft 212, e.g., with shaft locking collar 211. Preferably a plurality of support arms 106 are provided, with the support arms being equally-angularly-spaced from one another, e.g., 180 degrees apart if there are two support arms 106 or 120 degrees apart if there are three support arms 106, etc. In one preferred form of the invention, two diametrically-opposed support arms 106 are provided. An LED array 108 is secured to the distal end of each support arm 106. Each LED array 108 comprises at least one vertical column of LEDs. In one preferred form of the invention, two vertically-offset columns of LEDs are provided in each LED array 108. A hub electronics board 205, containing the electronics necessary to drive LED arrays 108 and containing the digital content which is to be displayed by LED arrays 108, is secured to one or more of support arms 106, so as to move (i.e., rotate) in unison therewith.

Power is delivered to hub electronics board 205 from power supply 201 via a contact-less rotary transformer. This contact-less rotary transformer comprises (i) a transformer stator 209 mounted to stator PCB 203 (which is mounted to motor 202) and connected to power supply 102, and (ii) a transformer rotor 210 mounted to rotor PCB 204 (which is mounted to a rotating arm 106) and connected to hub electronics board 205.

Photo-interrupter-type position sensor 207 is used to determine the rotational speed of motor shaft 212 (and hence the rotational speed of LED arrays 108). The digital content to be displayed on LED arrays 108 is delivered to hub electronics board 205 (which is mounted to rotating support arms 106) via a wireless ring antenna 206 (which is also carried by rotating support arms 106).

On account of the foregoing construction, rotary display 101 can be secured to a ceiling using ceiling mount 102, and the digital content which is to be displayed can be delivered to the rotary display via wireless antenna 206 and stored on hub electronics board 205. Then motor 202 can be started, causing support arms 106 (and hence LED arrays 108 carried on support arms 106) to rotate about motor shaft 212. CPU 502 on hub electronics board 205 pulses the LEDs in LED arrays 108 in an appropriate sequence, and at an appropriate rate, so as to present a fixed image to a viewer using the “persistence of vision” phenomenon associated with the human eye. In essence, this approach presents the digital data as a 360 degree translucent or transparent “floating” image, with the image being seen both directly and by reflection off the reflective interior of transparent display enclosure 104. See FIGS. 9 and 10, which show an example of rotary display 101 in use.

Another issue addressed in the present invention is adjusting display timing to the speed of rotation of motor 202. Repeated occurrences of the pulses generated by index sensor 207 are averaged so as to determine what the exact timing between the display columns needs to be. To accomplish this, an algorithm executed by the hub electronics hardware and software adjusts the number of clock pulses between column updates on a column by column basis.

A further technique is employed when information on the display is scrolling or otherwise in motion. In this case, sequencing of data to the individual support arms 106 (e.g., two support arms 106 in the preferred construction) is adjusted so as to compensate for the time delay between each arm successively passing before the viewer. For example, if the display is scrolling in the direction of rotation at a rate of 10 columns (horizontal pixels) per frame (full rotation of the display), data to the “180 degree” arm would be offset by 5 columns and data to the “zero degree” arm would be offset by 10 columns after one full rotation.

Another novel aspect of the present invention is its ability to manage its display content autonomously, or under external control, in conjunction with its ability to connect to standard public or private local or wide area wireless networks. By way of example but not limitation, the rotating display can communicate with a remote site so as to download the digital content which is to be displayed from that remote site, or upload data (e.g., display performance data) from the rotary display to a remote site, or communicate with other rotary displays (e.g., to share program content, etc.). Thus, for example, the rotary display might be programmed to retrieve content from a website, e.g., using the File Transfer Protocol (ftp) standard. In addition to display content, the data downloaded to the rotating display can include play instructions indicating how the image content should be displayed (e.g., fade, play video backwards, pop images at a programmable speed, etc.).

Furthermore, another novel aspect of the present invention is the ability of one rotary display to communicate directly with another rotary display, thereby enabling the creation of a peer-to-peer network of multiple rotary displays. Thus, among other things, such a peer-to-peer network of multiple rotary displays can be accessed through a single communications channel, directed to one or more of the networked rotary displays, so as to facilitate data transmission to some or all of the rotary displays. This approach also has the advantage that the desired digital content can be displayed at an otherwise-inaccessible location using the network of interconnected rotary displays to relay the desired digital content.

A network of interconnected rotary displays provides the ability to present synchronized and choreographed digital content using a plurality of interconnected rotary displays.

By way of example but not limitation, consider a hotel, school, airport or museum installation consisting of multiple networked rotary displays. With a rotary display disposed in adjacent rooms or areas, there would be no need for a supplemental building-wide wireless network: the communications network would be provided by the network of interconnected rotary displays as they pass digital content from one rotary display to the next, thereby allowing synchronized messaging to be displayed to the viewers.

The device's ability to be accessed remotely from virtually anywhere via the Internet makes it possible to maintain, diagnose, upgrade and modify software, as well as display instructions and content, in non-volatile reprogrammable memory and to re-program field programmable logic on hub electronics board 205.

If desired, a global positioning system (GPS) module can be incorporated in the rotary display, with the GPS communicating with hub electronics board 205, so that the location of the rotary display can be displayed to the viewer. Or the displayed content can be altered or customized based on the location of the rotary display. Thus, in one form of the invention, rotary display 101 includes a GPS module, and rotary display 101 uses this GPS module, wireless module 501 and wireless ring antenna 206 to report the location of the rotary display to a remote site which includes content management software, and the remote site pushes back site-appropriate digital content for display by rotary display 101.

### Some Significant Aspects Of The Present Invention

The following is a list of some significant aspects of the present invention.
The rotary display of the present invention provides for the remotely controlled display of information in a public place or workplace. Specifically, the rotary display permits viewing of digitally generated information, advertisements, news, weather, equipment status, etc. on an illuminated visual display which can be viewed from any direction. The rotary display incorporates one or more vertical arrays of LEDs which are rotated and pulsed in a precise sequence, and at a precise rate, so as to create a fixed image by taking advantage of the “persistence of vision” in the human eye.
The present invention provides a 360 degree viewable digital display, in the form of a translucent or transparent “floating” image, capable of displaying text and graphics. The rotary device is also capable of playing audio as a compliment to the displayed images.
The rotary display of the present invention has the ability to update its image and audio content via an industry standard wireless protocol such as cellular telephone (CDMA/GSM), Wi-Fi, Bluetooth, etc. connections. Thus, the rotary display can access, or be accessed, from any location which connects to a local or wide area wireless network, including the World Wide Web.
The images and video files displayed by the rotary display of the present invention are industry standard formats which require little or no reformatting, thereby providing a substantial cost saving in the creation of content for the display.
Power is supplied to the rotating display via an inductive rotary transformer consisting of a stationary and rotating ferrite mounted coil. Power is transferred from the stationary element to the rotating element across an air-gap without mechanical contact.
The design of the rotating display is based on one or more rotating LED arrays enclosed in a transparent cylindrical housing (i.e., transparent display enclosure 104) to provide safety and to minimize noise. These LED arrays are carried on support arms which are designed to minimize drag and turbulence in order to further minimize noise. Reflections from the inner surface of the housing further enhance the visual appeal of the display.
In one preferred form of the present embodiment, two LED arrays 108 are employed to provide the lowest flicker and to reduce the necessary rotation speed. With two LED arrays working in a synchronized fashion to create the image, the rotation rate of the motor can be reduced by half. Additional support arms 108 (carrying additional LED arrays 108) can be incorporated to further reduce motor speed and/or to increase effective display refresh rate.
The rotating display is designed to mount readily on a ceiling fan mount as well as on a pedestal or other form of stand. Only readily available domestic or industrial electrical power is required.
The rotary display is capable of displaying real-time equipment status information compliant with the SEMI E79 Specification for the Definition and Measurement of Equipment Productivity.

### Some Exemplary Applications Of The Invention

The present invention may be used in a wide range of different applications where digital content is to be displayed to a viewer. By way of example but not limitation, the present invention may be used to:
display images and video, including or excluding audio, for advertising, public messaging, factory productivity feedback (including equipment utilization), safety messages, emergency alerts, color coded text based messages and artistic displays;
display streaming or live video from one or more sources, including surveillance or other live video sources, and including 360 degree views via the use of multiple cameras or other video acquisition sources;
display streaming video from internet sources;
display interactive applications to engage a viewer e.g., to send a picture, video or text from a cellular telephone, personal digital assistant (PDA) or computer to be displayed on the sign; and/or
provide installations with multiple wirelessly networked units that can communicate with each other in order to share data and instructions and/or to create a coherent multi-unit installation, e.g., to include multiple synchronized or otherwise interactive installations.

### Modifications Of The Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. Apparatus for displaying digital content to a viewer, the apparatus comprising:
a rotary display, the rotary display comprising:
a motor having a motor shaft;
at least one support arm mounted to the motor shaft and extending radially outboard from the motor shaft;
at least one array of light-emitting elements mounted to the outboard end of the at least one support arm;
a wireless antenna mounted to the motor shaft; and
a controller mounted to the motor shaft for controlling operation of the at least one array of light-emitting elements, the controller being connected to the wireless antenna for receiving digital content received by the wireless antenna from a remote source and pushing that digital content to the at least one array of light-emitting elements in an appropriate sequence and at an appropriate rate so as to present a fixed image to a viewer using the “persistence of vision” phenomenon associated with the human eye.

2. Apparatus according to claim 1 wherein the wireless antenna is configured to receive digital content transferred via a wireless telephone connection.

3. Apparatus according to claim 1 wherein the wireless antenna is configured to receive digital content transferred via a Wi-Fi connection.

4. Apparatus according to claim 1 wherein the wireless antenna is configured to receive digital content transferred via a Bluetooth connection.

5. Apparatus according to claim 1 wherein the wireless antenna is in the shape of an annular ring, and further wherein the annular ring is disposed concentric to the motor shaft.

6. Apparatus according to claim 1 wherein the wireless antenna is mounted to the motor shaft by mounting the wireless antenna to the at least one support arm, which is in turn mounted to the motor shaft.

7. Apparatus according to claim 1 wherein the controller is mounted to the motor shaft by mounting the controller to the at least one support arm, which is in turn mounted to the motor shaft.

8. Apparatus according to claim 1 wherein the at least one array of light-emitting elements comprises at least two columns of light-emitting elements.

9. Apparatus according to claim 8 wherein the at least two columns of light-emitting elements are vertically-offset from one another.

10. Apparatus according to claim 9 wherein each column of light-emitting elements is vertically-offset from the adjacent column of light-emitting elements by 1/N the distance between adjacent light-emitting elements in the same column, where N is the number of columns of light-emitting elements in each of the at least one array of light-emitting elements.

11. Apparatus according to claim 1 wherein the light-emitting elements comprise light-emitting diodes (LEDs).

12. Apparatus according to claim 11 wherein each LED comprises a red light-emitting junction, a green light-emitting junction and a blue light-emitting junction.

13. Apparatus according to claim 1 wherein the at least one array of light-emitting elements is in the form of a planar array.

14. Apparatus according to claim 1 wherein the at least one array of light-emitting elements is in the form of an annular array.

15. Apparatus according to claim 1 further comprising a power supply for connection to line voltage and connected to the motor for powering the motor and connected to the controller for powering the controller and the at least one array of light-emitting elements.

16. Apparatus according to claim 15 wherein the power supply is connected to the controller via a contact-less rotary transformer.

17. Apparatus according to claim 16 wherein the contact-less rotary transformer comprises (i) a transformer stator mounted to the motor and connected to the power supply, and (ii) a transformer rotor mounted to the at least one support arm and connected to the controller.

18. Apparatus according to claim 17 wherein the transformer stator is separated from the transformer rotor by an air gap.

19. Apparatus according to claim 17 wherein the transformer stator and the transformer rotor are mounted concentric to the motor shaft.

20. Apparatus according to claim 1 further comprising a position sensor for determining the rate of rotation of the motor shaft, the position sensor being connected to the controller for timing the rate at which digital content is pushed to the at least one array of light-emitting elements.

21. Apparatus according to claim 20 wherein the position sensor comprises (i) a light source/light detector comprising a light source and a light detector separated by a gap, and (ii) a light interrupter for intermittent disposition across the gap, one of the light source/light detector and the light interrupter being mounted to the motor and the other of the light source/light detector and the light interrupter being mounted to the motor shaft.

22. Apparatus according to claim 1 further comprising a mount for mounting the motor to a stationary object.

23. Apparatus according to claim 22 wherein the stationary object is a ceiling.

24. Apparatus according to claim 22 wherein the stationary object is a pedestal.

25. Apparatus according to claim 1 wherein the apparatus comprises a plurality of support arms mounted to the motor shaft.

26. Apparatus according to claim 25 wherein the plurality of support arms are equally-angularly-spaced from one another.

27. Apparatus according to claim 26 wherein at least one array of light-emitting elements are mounted to the outboard end of each support arm.

28. Apparatus according to claim 1 wherein the fixed image comprises a 360 degree “floating” image.

29. Apparatus according to claim 1 further comprising a transparent display enclosure encompassing the at least one array of light-emitting elements of the rotary display.

30. Apparatus according to claim 29 wherein the interior of the transparent display enclosure is reflective so as to create the sense of a full 360 degree floating ring image from a single point of view.

31. Apparatus according to claim 1 wherein the wireless antenna is configured to receive digital content transferred via at least two of a wireless telephone connection, a Wi-Fi connection, and a Bluetooth connection, and further wherein the controller is adapted for simultaneous multi-mode access to multiple wireless connections.

32. Apparatus according to claim 1 wherein the controller is adapted for two-way communication with a remote site via the wireless antenna.

33. Apparatus according to claim 32 wherein the controller is adapted for two-way communication with a remote site via the Internet.

34. Apparatus according to claim 32 wherein the controller is adapted for two-way communication with another rotary display.

35. Apparatus according to claim 1 comprising a plurality of rotary displays, and further wherein the operation of each rotary display is coordinated with the operation the other rotary displays.

36. Apparatus according to claim 35 wherein the digital content displayed by one rotary display is coordinated with the digital content displayed by the other rotary displays.

37. A method for displaying digital content to a viewer, the method comprising:
providing a rotary display, the rotary display comprising:
a motor having a motor shaft;
at least one support arm mounted to the motor shaft and extending radially outboard from the motor shaft;
a least one array of light-emitting elements mounted to the outboard end of the at least one support arm;
a wireless antenna mounted to the motor shaft; and
a controller mounted to the motor shaft for controlling operation of the at least one array of light-emitting elements, the controller being connected to the wireless antenna for receiving digital content received by the wireless antenna from a remote source and pushing that digital content to the at least one array of light-emitting elements in an appropriate sequence and at an appropriate rate so as to present a fixed image to a viewer using the “persistence of vision” phenomenon associated with the human eye;
wirelessly transmitting digital content from a remote source to the controller via the wireless antenna; and
pushing the digital content from the controller to the at least one array of light-emitting elements in an appropriate sequence and at an appropriate rate so as to present a fixed image to a viewer using the “persistence of vision” phenomenon associated with the human eye.

38. A method according to claim 37 wherein digital content is transmitted from a remote source to the controller while the motor is rotating the motor shaft.

39. A method according to claim 38 wherein the controller transmits digital content to another rotary display.
